(19) United States
(12) Patent Application Publication
(10) Pub. No.: US 2006/0213286 A1
(43) Pub. Date: Sep. 28, 2006

(54) Intelligent laminated pressure surface

(76) Inventor: Juan Carlos Chasco Perez De Arenaza, Navarra (ES)

Correspondence Address: RATNERPRESTIA, P O BOX 980, VALLEY FORGE, PA, 19482-0980, US

(21) Appl. No.: 10/559,503

(22) PCT Filed: May 31, 2004
(86) PCT No.: PCT/ES04/00247

§ 371 Date: Apr. 14, 2006

(30) Foreign Application Priority Data
Jun. 5, 2003 (ES) P 2003 01387

(51) Int. Cl. G01D 7/00; G01L 1/04

(52) U.S. Cl. 73/862.041; 73/862.621

(57) ABSTRACT

The invention relates to an intelligent laminated pressure surface. The inventive surface consists of: an elastic sheet which is designed to measure a determined external pressure and which is provided with numerous holes, said holes extending from the surface to the base thereof; and two sheets having inner conductive faces which essentially cover both sides of said holes. According to the invention, the aforementioned pressure establishes a contact between the faces facing one another through the holes, thereby closing an electrical or optical conductor circuit. The invention can be used to locate determined pressures, evaluate the frequencies and intervals thereof and measure a pressure level or several pressure levels if more than one of the above-mentioned groups of sheets are disposed back-to-back. Moreover, the invention comprises an integrated conductor circuit and an antenna which alerts the user by means of an alarm or read device. The invention is particularly suitable for medical applications, such as in the prevention of diabetes foot, decubitus ulcers, etc.

### AIM OF THE INVENTION

This invention as explained in the title of this specification, relates to an improvement in the design and consequent use mainly for medical purposes of sheets with sensitive surfaces, which can receive information that can represent a risk for the wearer's skin.

### BACKGROUND TO THE INVENTION

The detailed description herein is mainly intended for medical application.

Patients can suffer from ailments which prevent them from noticing superficial pain (on their skin). For example, a small stone in their shoe. If a healthy person detects it, they easily solve the situation by removing the stone, however, anyone suffering from some specific ailments may not detect this foreign body and this can cause a wound that can worsen. This is typical and occurs frequently among those suffering from diabetes mellitus (4% of the population) who may suffer so-called diabetic neuropathy, with a high level of insensitivity. The resulting wound is the so-called diabetic ulcer, which has serious effects requiring long and expensive care, including long rest periods. In the US, almost 60,000 diabetic feet are amputated each year.

There are other cases such as the so-called decubitus ulcers, caused by an infrequently varied position (dementia, unconscious or coma patients . . . ) in bed or when seated. Different areas of the anatomy suffer excess pressure, since the bones press on the skin and this in turn, is pressed by the piece of furniture on which the patient is resting: bed, stretcher, chair. These pressures can exceed a certain risk level and have a temporary frequency, which it is usually interesting to know. That is, it may be advantageous to know how long the patient remains in the same position; in the event of a long period of immobility, the medical team must know this, assess the risk level, and if necessary, change the patient's position.

To summarise, it is a question of obtaining superficial pressure data relative to the patient, data that the patient does not provide by being the actual patient. Surfaces with sensors are known which operate on the basis of distributing resistances, mainly piezoresistors and piezoelectric elements. In order to adequately distinguish the pressure applied in each point, they produce considerable output signals with their electronic components, conversors and other added elements. This therefore makes a foot insole uncomfortable. In order to solve this situation, the surface of this invention can discriminate each point with a hole, but the signals determining the risk contact can be much fewer, which considerably simplifies the conductive system.

There are also models based on elastic sheets with conductive areas, such as patent DE 4418775 A1 which registers manually adjustable pressure levels and is used in traumatology, and includes rigid elements next to the skin and is limited in discriminating small objects. Patents EP0286054A1 and DE8910258.4 U1, the latter being an insulating elastic sheet with rounded or oval holes and conductive buttons on the upper conductive surface which, vis-à-vis certain pressure, comes into contact with the lower conductive part thus activating an alarm, acting by area and discriminating areas with various holes. It measures a pressure level in each hole, and determines the risk pressures in pre-established areas. In diabetic feet, it does not accurately detect particularly small foreign risk objects, and neither does it assess the pressure frequencies, or claim a smart system or optical or radical conduction. The pressure surface model of this invention can overcome these drawbacks.

The pressure surface of this invention, via small output signals, can assess any risk pressure, by measuring various levels such as for example, 0, 1, 2, 3 or more, which, for example, in a liquid crystal reader, would be equivalent to four colours in each discriminated area, one colour for each level measured and facilitated by using a smart system.

### DESCRIPTION OF THE INVENTION

The device of this invention consists of a laminate pressure surface (FIG. 1) comprising a non-conductive elastic sheet (e), with an abundance of holes (the shape and number of which is not claimed) which cross it from top to bottom; on both sides of said sheet there are two faces (c and c′) or conductive sheets covering at least the holes thereof.

An external pressure (for example, produced by the object lodged between the shoe and the sole) that exceeds a certain measurement, brings into contact the conductive faces that face each other through the holes, whereby the user knows that there has been at least one point of contact somewhere in sheet (e).

The areas of the conductive faces facing the holes have a suitable relief r (FIG. 1) for facilitating said conductive contact (flat, pyramidal, conical, etc.); no particular shape is claimed; also optionally a mobile conductive object can be placed inside the holes (m.o. in FIG. 1) to facilitate said contact.

The size and distribution of the holes makes it possible to detect any object whose pressure is sufficient to put the wearer's skin at risk.

The conductive faces can be insulated on the outside thereof (b and b′) to stabilise the system, and the face (b) directly receiving the impact can be given a relief that facilitates small objects approaching the holes.

At least one of the conductive faces is distributed by areas (z, in FIG. 2), and the contacts with the holes reach these areas, and 1, 5, 10 or all the holes can reach them, according to the accuracy with which the user desires to know the location of the impacts (greater to less respectively). Each conductive area emits a signal (FIG. 4).

### DESCRIPTION OF THE DRAWINGS

In order to improve the understanding of this specification description, several drawings are attached which represent, merely as an illustrative example, a practical embodiment of the smart laminate pressure surface (SPLI, in its abbreviated form in Spanish).

FIG. 1. “P.L.” section of smart laminate pressure surface, from the side, with insulating sheets (b) and (b′), conductive sheets (c) and (c′), elastic sheet (e), holes (o), relief (r) and an optional mobile object (e.g. a ball) which is also conductive (m.o).

FIG. 2. Laminate pressure surface broken down into sheets: from top to bottom, in perspective (b), (c), (e) broken down towards the right, (c′) and (b′).

FIG. 3. “P.L.” section of smart laminate pressure surface, from the side, with insulating sheets (b), (f), (b′), conductive sheets (c), (Fs), (Fi), (c′), elastic sheets (e) and holes (o).

FIG. 4. Basic circuit. “C.B.” conductor, in this case, electrical: with generator, wiring, conducting areas (z) from which a signal is emitted, alarm devices (AL), reading device (L.c.), integrated circuit (c.i.), antenna (a) and as an example on the right of the drawing, holes (o) in an elastic sheet (e) that can receive a conductive area (z).

FIG. 5. Smart laminate pressure surface, with its sheets broken down from top to bottom and in perspective: (b), (c), (e) broken down also towards the right, (Fs), (f), (Fi), (e) also broken down towards the right, (c′) and (b′); (p) direct pressure receiver (objects, foot, etc.); (c′) and (Fs) are distributed according to areas (z).

FIG. 6. “C.T.” section of smart laminate pressure surface, in the event of two possible foreign objects with different pressure: left, minimum pressure (m) and right, maximum pressure (M); top, pressure action “P”, and bottom, pressure resistance “R”, both with their indicator vectors, and the various sheets from top to bottom: (b), (c), (e), (Fs), (f), (Fi), (e), (c′), (b′).

### DESCRIPTION OF A PREFERRED EMBODIMENT

The device of this invention is a smart laminate pressure surface (SPLI in its abbreviated form in Spanish) comprising a non-conductive elastic sheet (e), with an abundance of holes (the shape and number of which are not claimed) that cross it from top to bottom; on both sides of said sheet there are two sheets, (c and c′) the inner faces of which are conductive, and which mainly cover said holes.

A certain pressure (for example, as mentioned above, a shoe insole; the pressure produced by the object that lodged between the shoe and the bottom of the foot), brings into contact the conductive faces facing each other through the holes, therefore forming a conductive circuit.

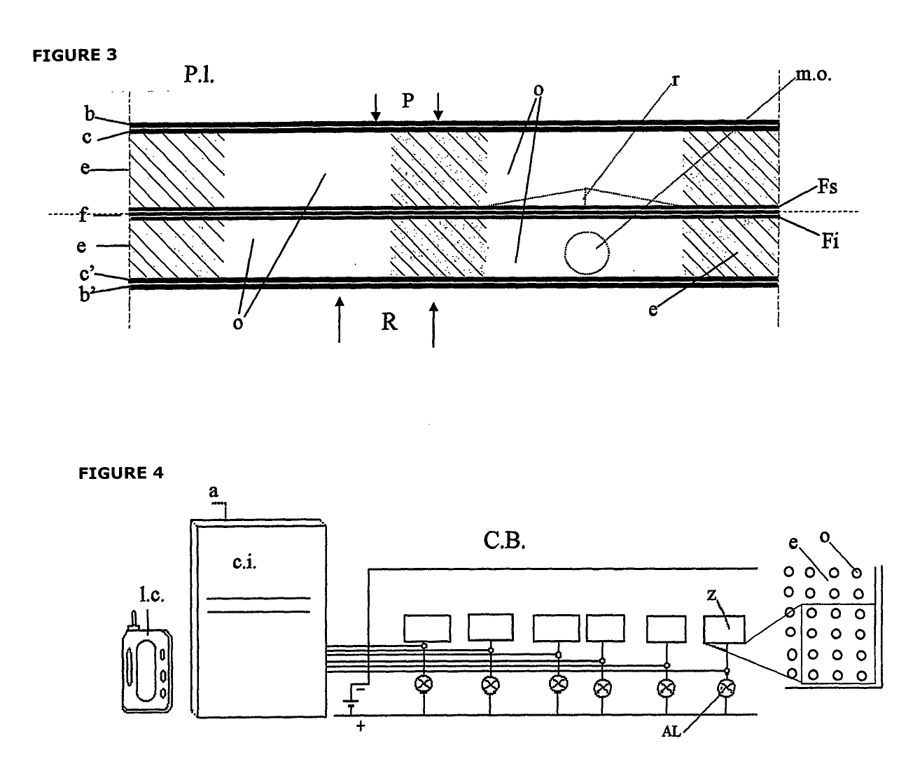

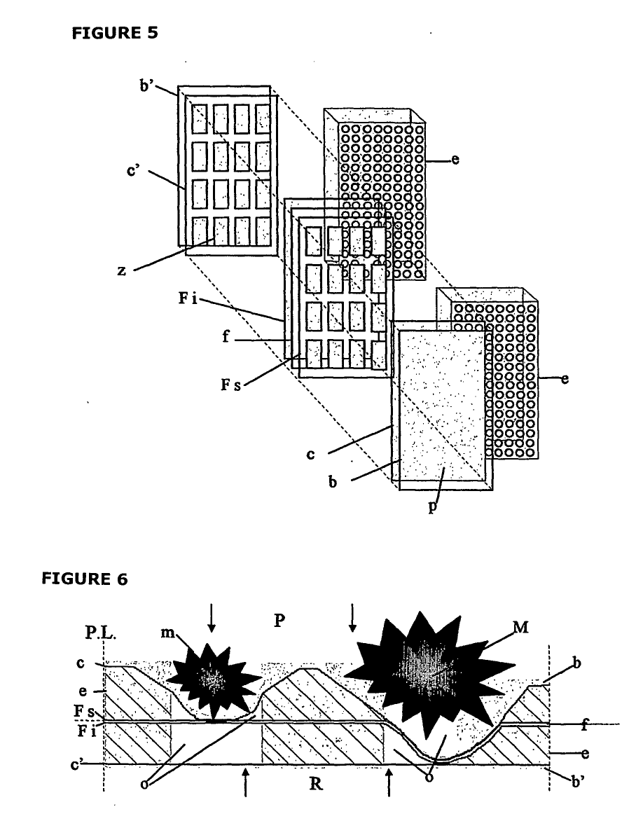

By means of these three sheets a pressure level can be measured, with each new level to be measured involving another laminate pressure group such as the one just described, backing onto it, (FIG. 3) and with an adjustment of the corresponding physical-mechanical properties.

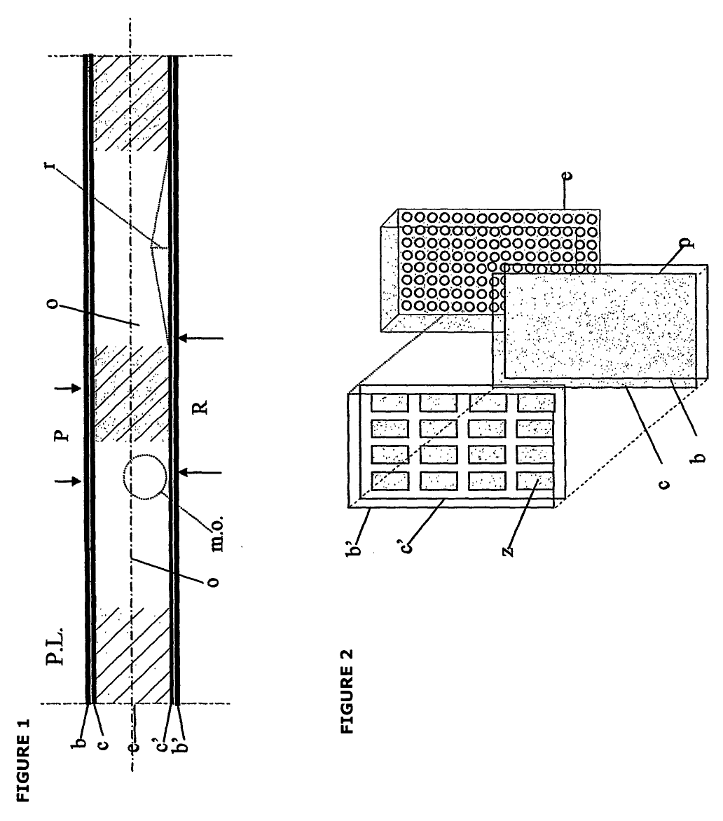

The areas of the conductive faces facing the holes have a suitable relief (r, FIG. 1) for facilitating said conductive contact (flat, pyramidal, conical, etc.), which is not claimed; said contact is also facilitated by optionally installing a mobile object, for example, rounded: “m.o.” in FIG. 1, which goes inside the holes, and neither the shape or composition of said object is claimed.

The size and distribution of the holes makes it possible to notice any object whose pressure puts the wearer's skin at risk.

The face directly receiving the impacts (always “b”, in the various drawings) has a relief that facilitates small objects approaching the holes.

The conductive faces are distributed in areas (“z” in FIGS. 2 and 4), and the contacts with the holes reach these areas, and 1, 5, 10 or all the holes can reach them, according to the accuracy with which the user desires to know the location of the impacts (respectively from greater to lesser pressure). Each conductive area emits a signal (FIG. 4). The size and distribution of the areas on each conductive face are adjusted to the space to be measured. (Let's say the system is prepared to detect any small risk object, but it may be of interest that the location of the object is more or less accurate).

FIG. 6 shows on the left-hand side a “minimum contact” (m) with a foreign object, via the external pressure for example of a foot, which deforms the laminate pressure surface downwards, that allowing the inner face of sheet (c) to come into contact with the upper face (Fs) of f, both conductive faces, which the circuit detects. And the same FIG. 6 shows, on the right-hand side, an example of “maximum” contact which brings the lower face (Fi) of f into contact with the upper face (c′) of both conductive elements, and the circuit also detects this contact. The smart laminate pressure surface (SPLI, in its abbreviated form in Spanish) indicates to the wearer that there are risk objects in his/her shoe and that he/she can remove them. As for the shape of the laminate pressure surface, this can be standard or made to measure. For example, insoles for various shoe sizes; surfaces of the size of a hospital bed sheet, or smaller surfaces, to monitor particular areas of the patient's bed.

The circuit comprises an accurate generator, either electrical (FIG. 4), or optical or both combined, since the signals conducted may be of the three types.

The smart laminate pressure surface (SPLI, in its abbreviated form in Spanish) can also assess pressure or impact frequencies, with its varied measurements, and the interruption frequencies.

All the information is gathered (FIG. 4) via the wiring and taken to alarm devices (AL) (that can be optical, acoustic, or combined optical and acoustical devices) or to reading devices (L.c) also in a smart integrated circuit (c.i.) which interprets them according to the program, and notifies the wearer. The signals can be conducted or radiated (a).

Finally, if it is desirable to determine the location of the pressure contacts, the two conductive faces are distributed according to areas, of varying size, with a signal being emitted from each area, although there may be several simultaneous contacts, and each area can comprise one, several or all of the holes.

If it is desirable to measure more than one pressure level, two or more pressure surfaces can be stacked, sandwich style, joining the faces of the laminate pressure surfaces that come into contact, and just considering the modifications made.

Its application is mainly medical: such as in the prevention of diabetic foot and decubitus ulcers. It is also intended for non-medical applications: where it is desirable to detect one or several pressures. Acting as a mechanism or with a servomechanism, to prevent a risk (for example in safety and footwear), for keyboard operation, and for diagnosing pressure distributions over a surface.

1-5. (canceled)

6. A pressure detection device having at least one configuration comprising:
a non-conductive intermediate elastic sheet having a plurality of holes through it;
two sheets with inner conductive faces backing onto both sides of said intermediate sheet so that they cover at least said holes leaving the respective inner conductive faces facing each other through said holes, so that when a certain external pressure is applied on said device it is deformed such that said inner conductive faces establish a conductive contact between them through one or more of said holes, therefore forming at least one conductive circuit; and
at least one of the conductive faces is distributed by conductive areas, each of them covering one or more of said holes depending on whether more or less accuracy is desired, respectively, regarding the location of the hole through which said conductive contact has been made.

7. The device according to claim 6, wherein said distribution in said conductive areas of at least said conductive face, comprises different size conductive areas covering a different number of holes.

8. The device according to claim 6, wherein at least one of the areas of the conductive faces of said conductive sheets, facing holes, has a suitable relief for facilitating the establishment of said conductive contact with the conductive face of the opposite sheet.

9. The device according to claim 8, wherein said contact facilitating relief is at least of the type included in the group made up of flat, pyramidal and conical type relieves.

10. The device according to claim 6, wherein at least one of said holes houses in its interior at least one mobile object that is conductive at least in the surface thereof, so that said conductive contact is established, via a mobile object, between the two conductive faces of said conductive sheets covering said hole, which is at least one, with less external pressure being applied to the device.

11. The device according to claim 10, wherein said mobile object has a rounded shape.

12. The device according to claim 6, wherein at least said inner conductive faces of said conductive sheets are suitable for producing, when said certain pressure is applied, an electrical or optical conductive contact, or a combination of both.

13. The device according to claim 6, wherein it comprises several of said configurations stacked on top of one another.

14. The device according to claim 13, wherein said configurations stacked on top of one another have common holes through which different conductive areas appear at different heights.

15. The device according to claim 6, wherein at least one of said conductive sheets, or insulating sheets backed onto the free surfaces of said conductive sheets, which can directly receive pressure impacts from small objects, has a relief that facilitates said small objects approaching or moving towards holes.

16. The device according to claim 6, wherein each conductive face and/or each of said conductive areas is connected to at least a contact through which it is possible to send a signal indicating conduction with the opposite face or area.

17. The device according to claim 16, wherein it comprises a system with at least one electrical or optical energy generator, or a combination of both, connected to at least one of said conductive faces and/or one of said conductive areas, and alarm devices connected at least to said contacts on said conductive faces and/or said conductive areas.

18. The device according to claim 16, wherein it comprises an electronic system with at least an integrated circuit, connected via corresponding wiring to the contacts on said conductive faces and/or said conductive areas to receive, following corresponding digitalisation, said conduction indication signals and process them so that they can be interpreted to at least locate the area, or areas, where said certain pressure has been produced.

19. The device according to claim 18, wherein said integrated circuit is suitable also for measuring the frequency with which said signals are produced and/or their variations according to the pressure intensity.

20. The device according to claim 18, wherein said integrated circuit is suitable for sending information on said interpretation at least via electrical and/or optical means, via wiring or radio, by means of a corresponding antenna, and/or via a luminous or acoustic signal or via a screen.

21. The device according to claim 20, wherein said system comprises a reading device associated with said integrated circuit and suitable for receiving said information sent by said circuit.

22. The device according to claim 18, wherein said electronic system is associated with a system having at least one electrical or optical energy generator, or a combination of both, connected to at least one of said conductive faces and/or one of said conductive areas, and alarm devices connected at least to the contacts on said conductive faces and/or said conductive areas.

23. The device according to claim 10, wherein it comprises at least a portion a shoe insole.

24. The device according to claim 18, wherein said electronic system comprises a microcomputer or a smart circuit and said device comprises at least a portion a shoe insole.
